(19) United States
(12) Patent Application Publication
(10) Pub. No.: US 2009/0055171 A1
(43) Pub. Date: Feb. 26, 2009

(54) BUZZ REDUCTION FOR LOW-COMPLEXITY FRAME ERASURE CONCEALMENT

(75) Inventor: Robert W. Zopf, Rancho Santa Margarita, CA (US)

Correspondence Address: FIALA & WEAVER, P.L.L.C.;C/O INTELLEVATE, P.O. BOX 52050, MINNEAPOLLS, MN, 55402, US

(73) Assignee: BROADCOM CORPORATION, Irvine, CA (US)

(21) Appl. No.: 12/179,277

(22) Filed: Jul. 24, 2008

Related U.S. Application Data
(60) Provisional application No. 60/956,753, filed on Aug. 20, 2007.

(51) Int. Cl. G10L 21/02

(52) U.S. Cl. 704/228; 704/E21.001

(57) ABSTRACT

A system is described that performs periodic waveform extrapolation based frame erasure concealment (FEC) to generate frames of an output speech signal corresponding to erased frames of encoded bit-stream in a manner reduces buzzy and tonal artifacts in the output speech signal. An embodiment of the invention uses a multiple of a pitch period associated with previously-decoded speech to perform periodic waveform extrapolation for consecutively-erased frames in a frame erasure beyond the first erased frame. An embodiment of the invention also attenuates the extrapolated signal after a threshold number of erased frames so as to reduce the FEC output signal to zero, wherein the threshold number of erased frames is dependent at least in part on the pitch period associated with the previously-decoded speech.

### CROSS-REFERENCE TO RELATED APPLICATIONS

This application claims priority to U.S. Provisional Patent Application No. 60/956,753 entitled “Buzz Reduction for Low-Complexity Packet Loss Concealment,” filed Aug. 20, 2007, the entirety of which is incorporated by reference herein.

### BACKGROUND OF THE INVENTION

1. Field of the Invention

The present invention relates to digital communication systems. More particularly, the present invention relates to the enhancement of speech quality when portions of a bit stream representing a speech signal are lost within the context of a digital communications system.

2. Background Art

In speech coding (sometimes called “voice compression”), a coder encodes an input speech or audio signal into a digital bit stream for transmission. A decoder decodes the bit stream into an output speech signal. The combination of the coder and the decoder is called a codec. The transmitted bit stream is usually partitioned into segments called frames, and in packet transmission networks, each transmitted packet may contain one or more frames of a compressed bit stream. In wireless or packet networks, sometimes the transmitted frames or packets are erased or lost. This condition is called frame erasure in wireless networks and packet loss in packet networks. When this condition occurs, to avoid substantial degradation in output speech quality, the decoder needs to perform frame erasure concealment (FEC) or packet loss concealment (PLC) to try to conceal the quality-degrading effects of the lost frames. Because the terms FEC and PLC generally refer to the same kind of technique, they can be used interchangeably. Thus, for the sake of convenience, the term “frame erasure concealment”, or FEC, is used herein to refer to both.

One of the earliest FEC techniques is waveform substitution based on pattern matching, as proposed by Goodman, et al. in “Waveform Substitution Techniques for Recovering Missing Speech Segments in Packet Voice Communications”, IEEE Transaction on Acoustics, Speech and Signal Processing, December 1986, pp. 1440-1448. This scheme was applied to a Pulse Code Modulation (PCM) speech codec that performs sample-by-sample instantaneous quantization of a speech waveform directly. This FEC scheme uses a piece of decoded speech waveform that immediately precedes the lost frame as a template, and then slides this template back in time to find a suitable piece of decoded speech waveform that maximizes some sort of waveform similarity measure (or minimizes a waveform difference measure).

Goodman's FEC scheme then uses the section of waveform immediately following a best-matching waveform segment as the substitute waveform for the lost frame. To eliminate discontinuities at frame boundaries, the scheme also uses a raised cosine window to perform an overlap-add operation between the correctly decoded waveform and the substitute waveform. This overlap-add technique increases the coding delay. The delay occurs because at the end of each frame, there are many speech samples that need to be overlap-added, and thus final values cannot be determined until the next frame of speech is decoded.

Based on the work of Goodman as described above, David Kapilow developed a more sophisticated version of an FEC scheme for the G.711 PCM codec. This FEC scheme is described in Appendix I of the ITU-T Recommendation G.711.

The FEC schemes of Goodman and Kapilow are both limited to PCM codecs that use instantaneous quantization. Such PCM codecs are block-independent; that is, there is no inter-frame or inter-block codec memory, so the decoding operation for one block of speech samples does not depend on the decoded speech signal or speech parameters in any other block.

All PCM codecs are block-independent codecs, but a block-independent codec does not have to be a PCM codec. For example, a codec may have a frame size of 20 milliseconds (ms), and within this 20 ms frame there may be some codec memory that makes the decoding of certain speech samples in the frame dependent on decoded speech samples or speech parameters from other parts of the frame. However, as long as the decoding operation of each 20 ms frame does not depend on decoded speech samples or speech parameters from any other frame, then the codec is still block-independent.

One advantage of a block-independent codec is that there is no error propagation from frame to frame. After a frame erasure, the decoding operation of the very next good frame of transmitted speech data is completely unaffected by the erasure of the immediately preceding frame. In other words, the first good frame after a frame erasure can be immediately decoded into a good frame of output speech samples.

For speech coding, the most popular type of speech codec is based on predictive coding. Perhaps the first publicized FEC scheme for a predictive codec is a “bad frame masking” scheme in the original TIA IS-54 VSELP standard for North American digital cellular radio (rescinded in September 1996). One of the first FEC schemes for a predictive codec that performs waveform extrapolation in the excitation domain is the FEC system developed by Chen for the ITU-T Recommendation G.728 Low-Delay Code Excited Linear Predictor (CELP) codec, as described in U.S. Pat. No. 5,615,298 issued to Chen, entitled “Excitation Signal Synthesis During Frame Erasure or Packet Loss.” After the publication of these early FEC schemes for predictive codecs, many, many other FEC schemes have been proposed for predictive codecs, some of which are quite sophisticated.

Despite the fact that most of the speech codecs standardized in the last twenty years are predictive codecs, there are still some applications, such as Voice over Internet Protocol (VoIP), where the G.711 (8-bit logarithmic PCM) codec, or even the 16-bit linear PCM codec, is still used in order to ensure very high signal fidelity. In such applications, none of the advanced FEC schemes developed for predictive codecs can be used, and typically G.711 Appendix I (Kapilow's FEC scheme) is used instead. However, G.711 Appendix I has the following drawbacks: (1) it requires an additional delay of 3.75 ms due to the overlap-add, (2) it has a fairly large state memory requirement due to the use of a long history buffer with a length of three and a half times the maximum pitch period, and (3) its performance is not as good as it can be.

Commonly-owned, co-pending U.S. patent application Ser. No. 11/234,291 to Chen, entitled “Packet Loss Concealment For Block-Independent Speech Codecs,” filed on Sep. 26, 2005, describes an FEC scheme that avoids the three drawbacks of G.711 Appendix I mentioned above. However, for certain applications of FEC, such as Bluetooth™ headset applications, the emphasis is on extremely low complexity due to the low cost and low power dissipation requirements. Although the FEC scheme described in U.S. patent application Ser. No. 11/234,291 does not introduce additional delay, has lower state memory requirement than G.711 Appendix I, and produces better speech quality than G.711 Appendix I, its computational complexity and required code size may still exceed the limit for some extremely low complexity applications. To address this, commonly-owned, co-pending U.S. patent application Ser. No. 12/147,781 to Chen, entitled “Low-Complexity Frame Erasure Concealment,” filed on Jun. 27, 2008, describes an FEC technique that maintains the benefits of the FEC scheme described in U.S. patent application Ser. No. 11/234,291 and yet has much lower computational complexity and code size.

In the FEC technique described in U.S. patent application Ser. No. 12/147,781, periodic waveform extrapolation is used to generate a substitute waveform for every erased frame. This approach may introduce artificially-created periodicity into the output speech signal that was not present in the original speech signal. This periodicity may be perceived by a listener as a “buzz” or tonal sound.

In certain implementations, the foregoing problem will not arise as long as frame erasures are isolated. For example, in one implementation, the original speech signal is encoded using CVSD (Continuously Variable Slope Delta-modulation) and carried in frames of 30 samples each and a minimum pitch period of 20 samples is used for performing periodic waveform extrapolation. In such an implementation, the extrapolated waveform generated due to an isolated frame erasure will not encompass 2 or more pitch cycles. Consequently, it will not be easy to perceive any artificially-introduced periodicity in the output speech signal.

However, if consecutive frames are erased in such an implementation, the extrapolated waveform generated to replace the erased frames may encompass multiple pitch cycles, depending on the number of consecutively-erased frames and the pitch period. This will potentially produce audible buzzy or tonal artifacts in the output speech signal. Generally speaking, in such an implementation, some buzzy or tonal artifacts may be audible after 3 to 5 repeated pitch cycles.

What is needed, then, is a system and method for reducing buzzy and tonal artifacts in an output speech signal produced by a periodic waveform extrapolation based FEC algorithm, such as the FEC algorithm described in U.S. patent application Ser. No. 12/147,781.

### SUMMARY OF THE INVENTION

As described herein, an embodiment of the present invention reduces buzzy and tonal artifacts in an output speech signal produced by a periodic waveform extrapolation based frame erasure concealment (FEC) algorithm. To reduce such buzzy and tonal artifacts, an embodiment of the present invention uses a multiple of a pitch period associated with previously-decoded speech to perform periodic waveform extrapolation for consecutively-erased frames in a frame erasure beyond the first erased frame. In one implementation, a multiple of the pitch period is used only if it is detected that the speech waveform is evolving sufficiently from one cycle to the next such that simply performing periodic waveform extrapolation at the pitch period will most likely result in buzzy or tonal artifacts.

An embodiment of the present invention also provides a solution for processing a series of consecutively-erased frames that is so long that performing periodic waveform extrapolation using a pitch period multiple may still result in the generation of buzzy or tonal artifacts. In accordance with such an embodiment, the extrapolated signal is attenuated after a threshold number of erased frames so as to reduce the FEC output signal to zero, wherein the threshold number of erased frames is dependent at least in part on the pitch period associated with the previously-decoded speech.

In particular, a method is described herein for processing a series of erased frames of an encoded bit-stream to generate corresponding frames of an output speech signal. In accordance with the method, a pitch period associated with a previously-generated portion of the output speech signal is estimated. Periodic waveform extrapolation is performed based on the pitch period to generate a frame of the output speech signal corresponding to a first erased frame in the series of erased frames. Periodic waveform extrapolation is then performed based on a multiple of the pitch period to generate one or more frames of the output speech signal corresponding to one or more erased frames that follow the first erased frame in the series of erased frames.

In one implementation of the foregoing method, performing periodic waveform extrapolation based on the multiple of the pitch period to generate the one or more frames of the output speech signal corresponding to the one or more erased frames that follow the first erased frame in the series of erased frames comprises one or more steps. In accordance with these steps, a parameter is calculated that is representative of a rate at which the previously-generated portion of the output speech signal is evolving over consecutive pitch periods. Periodic waveform extrapolation is then selectively performed based on either the pitch period or the multiple of the pitch period to generate the one or more frames of the output speech signal corresponding to the one or more erased frames that follow the first erased frame in the series of erased frames depending on the value of the parameter.

A method is also described herein for processing an erased frame in a series of erased frames of an encoded-bit stream to generate a corresponding frame of an output speech signal. In accordance with the method, periodic waveform extrapolation is performed to generate a frame of the output speech signal corresponding to the erased frame. A duration of an erasure is calculated based on a number of consecutively-processed erased frames in the series of erased frames. A threshold is calculated based on at least a pitch period associated with a previously-generated portion of the output speech signal. It is then determined whether the duration of the erasure equals or exceeds the threshold. Responsive to determining that the duration of the erasure equals or exceeds the threshold, gain attenuation is applied to the generated frame of the output speech signal.

Depending upon the implementation, calculating the threshold based on at least the pitch period associated with the previously-generated portion of the output speech signal may include calculating the threshold as a multiple of the pitch period. Calculating the threshold based on at least the pitch period associated with the previously-generated portion of the output speech signal may also include calculating the threshold as the minimum of a predetermined number of frames multiplied by a number of samples in each frame and a multiple of the pitch period.

A computer program product is also described herein. The computer program product includes a computer-readable medium having computer program logic recorded thereon for enabling a processing unit to process a series of erased frames of an encoded bit-stream to generate corresponding frames of an output speech signal. The computer program logic includes first means, second means and third means. The first means are for enabling the processing unit to estimate a pitch period associated with a previously-generated portion of the output speech signal. The second means are for enabling the processing unit to perform periodic waveform extrapolation based on the pitch period to generate a frame of the output speech signal corresponding to a first erased frame in the series of erased frames. The third means are for enabling the processing unit to perform periodic waveform extrapolation based on a multiple of the pitch period to generate one or more frames of the output speech signal corresponding to one or more erased frames that follow the first erased frame in the series of erased frames.

In accordance with one implementation of the foregoing computer program product, the third means comprises means for enabling the processing unit to calculate a parameter representative of a rate at which the previously-generated portion of the output speech signal is evolving over consecutive pitch periods and means for enabling the processing unit to selectively perform periodic waveform extrapolation based on either the pitch period or the multiple of the pitch period to generate the one or more frames of the output speech signal corresponding to the one or more erased frames that follow the first erased frame in the series of erased frames depending on the value of the parameter.

An additional computer program product is described herein. The computer program product includes a computer-readable medium having computer program logic recorded thereon for enabling a processing unit to process an erased frame in a series of erased frames of an encoded-bit stream to generate a corresponding frame of an output speech signal. The computer program logic includes first means, second means, third means, fourth means and fifth means. The first means are for enabling the processing unit to perform periodic waveform extrapolation to generate a frame of the output speech signal corresponding to the erased frame. The second means are for enabling the processing unit to calculate a duration of an erasure based on a number of consecutively-processed erased frames in the series of erased frames. The third means are for enabling the processing unit to calculate a threshold based on at least a pitch period associated with a previously-generated portion of the output speech signal. The fourth means are for enabling the processing unit to determine whether the duration of the erasure equals or exceeds the threshold. The fifth means are for enabling the processing unit to apply gain attenuation to the generated frame of the output speech signal responsive to determining that the duration of the erasure equals or exceeds the threshold.

In accordance with one implementation of the foregoing computer program product, the third means includes means for enabling the processing unit to calculate the threshold as a multiple of the pitch period. In accordance with an alternate implementation of the foregoing computer program product, the third means includes means for enabling the processing unit to calculate the threshold as the minimum of a predetermined number of frames multiplied by a number of samples in each frame and a multiple of the pitch period.

Further features and advantages of the present invention, as well as the structure and operation of various embodiments of the present invention, are described in detail below with reference to the accompanying drawings. It is noted that the invention is not limited to the specific embodiments described herein. Such embodiments are presented herein for illustrative purposes only. Additional embodiments will be apparent to persons skilled in the art based on the teachings contained herein.

### BRIEF DESCRIPTION OF THE DRAWINGS/FIGURES

The accompanying drawings, which are incorporated herein and form a part of the specification, illustrate one or more embodiments of the present invention and, together with the description, further serve to explain the purpose, advantages, and principles of the invention and to enable a person skilled in the art to make and use the invention.

FIG. 1 is a block diagram of a system that implements a frame erasure concealment (FEC) technique in accordance with an embodiment of the present invention.

FIG. 2 is an illustration of different classes of frames of an input bit-stream distinguished by an embodiment of the present invention.

FIG. 3 is a flowchart of a method for performing FEC in accordance with an embodiment of the present invention.

FIG. 4 is a block diagram of an example computer system that may be configured to implement an embodiment of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF INVENTION

### A. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that the while the following description of the present invention describes the processing of speech signals, the invention can be used to process any kind of general audio signal. Therefore, the term “speech” is used purely for convenience of description and is not limiting. Whenever the term “speech” is used, it can represent either speech or a general audio signal. Furthermore, it should also be understood that while most of the algorithm parameters described below are specified assuming a sampling rate of 8 kHz for telephone-bandwidth speech, persons skilled in the art should be able to extend the techniques presented below to other sampling rates, such as 16 kHz for wideband speech. Therefore, the parameters specified are only meant to be exemplary values and are not limiting.

### B. System in Accordance with an Embodiment of the Present Invention

The exemplary frame erasure concealment (FEC) technique described below is a modified version of a low-complexity FEC technique described in commonly-owned, co-pending U.S. patent application Ser. No. 12/147,781 to Chen, entitled “Low-Complexity Frame Erasure Concealment” and filed on Jun. 27, 2008, the entirety of which is incorporated by reference herein. In the FEC technique described in U.S. patent application Ser. No. 12/147,781, periodic waveform extrapolation is used to generate a substitute waveform for every erased frame. This approach may introduce artificially-created periodicity into the output speech signal that was not present in the original speech signal. This periodicity may be perceived by a listener as a “buzz” or tonal sound.

In certain implementations, the foregoing problem will not arise as long as frame erasures are isolated. For example, in one implementation, the original speech signal is encoded using CVSD (Continuously Variable Slope Delta-modulation) and carried in frames of 30 samples each and a minimum pitch period of 20 samples is used for performing periodic waveform extrapolation. In such an implementation, the extrapolated waveform generated due to an isolated frame erasure will not encompass 2 or more pitch cycles. Consequently, it will not be easy to perceive any artificially-introduced periodicity in the output speech signal.

However, if consecutive frames are erased in such an implementation, the extrapolated waveform generated to replace the erased frames may encompass multiple pitch cycles, depending on the number of consecutively-erased frames and the pitch period. This will potentially produce audible buzzy or tonal artifacts in the output speech signal. Generally speaking, in such an implementation, some buzzy or tonal artifacts may be audible after 3 to 5 repeated pitch cycles.

To reduce such buzzy or tonal artifacts, an embodiment of the present invention uses a multiple of a pitch period associated with previously-decoded speech to perform periodic waveform extrapolation (rather than the pitch period itself as is used in U.S. patent application Ser. No. 12/147,781) for consecutively-erased frames in a frame erasure beyond the first erased frame. However, a multiple of the pitch period is used only if it is detected that the speech waveform is evolving sufficiently from one cycle to the next such that simply performing periodic waveform extrapolation at the pitch period will most likely result in buzzy or tonal artifacts.

Most voiced speech is highly periodic. Yet, a speech waveform generally evolves from one pitch period to the next. In light of this observation, it makes sense that one way to reduce the periodicity produced by periodic waveform extrapolation is to use a multiple of the pitch period. For example, by increasing the period at which the waveform is repeated, the length of the extrapolated waveform required to encompass 3-5 identical pitch cycles will be extended. The use of a pitch period multiple also makes sense for unvoiced speech or background noise. For these types of waveforms, repeating the random-like signal at a longer pitch period will extend the time before which a listener can perceive any artificially-introduced periodicity.

It is noted, however, that there are some instances in spoken speech where a voiced sound is held for multiple pitch periods. A constant vocal tract will yield a waveform that does not evolve noticeably from one pitch cycle to the next. In such cases, if the frame erasure occurs within a few pitch cycles after the speech waveform became relatively stationary, using a multiple of the pitch period may repeat a cycle that is very different, and a significant artifact may result. Also, as was described previously, where the frame size is small (e.g., 30 CVSD-encoded samples), an audible buzz sound will likely not be introduced due to the replacement of a single erased frame. Therefore, an embodiment of the present invention does not use pitch multiples for performing periodic waveform extrapolation in the first erased frame of an erasure.

An embodiment of the present invention also provides a solution for processing a series of consecutively-erased frames that is so long that performing periodic waveform extrapolation using a pitch period multiple may still result in the generation of buzzy or tonal artifacts. One approach described in U.S. patent application Ser. No. 12/147,781 is to attenuate the extrapolated signal after some fixed number of erased frames so as to reduce the FEC output signal toward zero. The attenuation may be performed by applying an exponentially-decaying gain to the extrapolated signal. An alternative approach in accordance with an embodiment of the present invention is to make the threshold after which attenuation is applied dependent on the pitch period. It may still be desired to limit the total time period during which the extrapolated waveform is audible. In accordance with a further embodiment of the present invention, this is achieved by using the minimum of the adaptive threshold that is based on the pitch period and a fixed threshold that is strictly based on the number of consecutively-erased frames as the threshold after which attenuation is applied.

Although the exemplary FEC system described below is a modified version of the FEC system described in U.S. patent application Ser. No. 12/147,781, persons skilled in the relevant art(s) will readily appreciate that the inventive concepts described herein can be broadly applied to any system that uses some form of periodic waveform extrapolation to perform FEC.

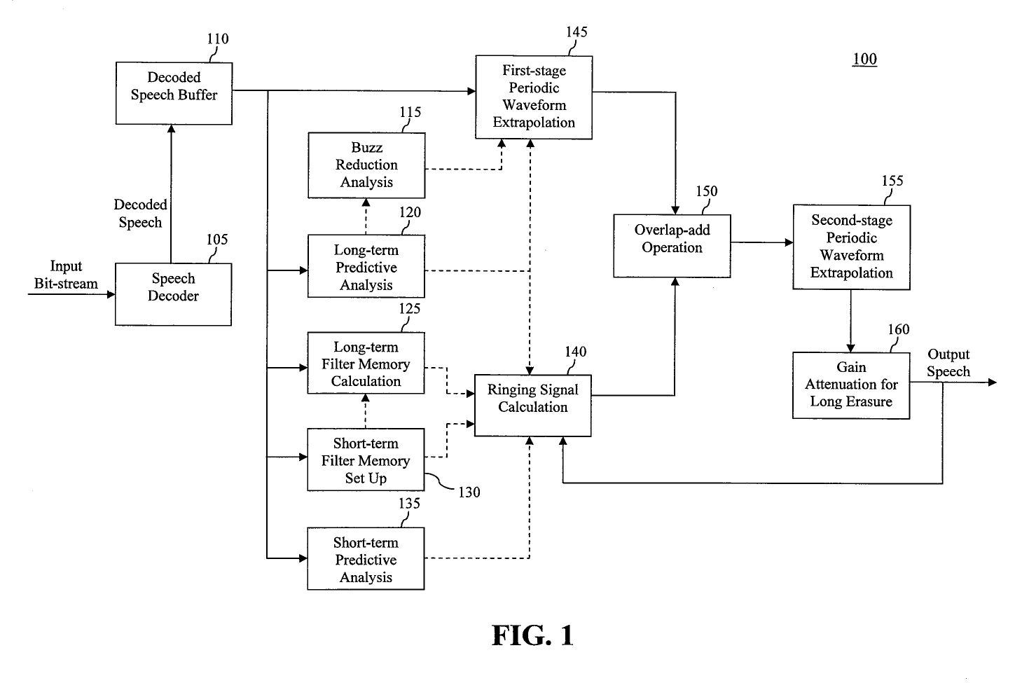

An illustrative block diagram of a system 100 that performs FEC in accordance with an embodiment of the present invention is shown in FIG. 1. Generally speaking, system 100 is configured to decode an encoded bit-stream that has been received over a transmission medium to generate an output speech signal. In particular, system 100 is configured to decode discrete segments of the input bit-stream to produce corresponding discrete segments of the output speech signal. These discrete segments are termed frames. If a frame of the input-bit stream is corrupted, delayed or lost during transmission over the transmission medium, then the frame may be deemed “erased,” which generally means that the frame is not available for decoding or cannot be reliably decoded. As will be described in more detail below, system 100 is configured to perform operations that conceal the quality-degrading effects associated with such frame erasure.

As used herein, the terms “erased frame” or “bad frame” are intended to denote a frame of the input bit-stream that has been deemed erased while the terms “received frame” or “good frame” are used to denote a frame of the input bit-stream that has not been deemed erased. Furthermore, as used herein, the term “erasure” refers to both a single erased frame as well as a series of consecutive erased frames.

In an embodiment, each frame of the input bit-stream processed by system 100 is classified into one of four different classes. These classes are (1) the first bad frame of an erasure—if the erasure consists of a consecutive series of bad frames, the first bad frame of the series is placed in this class and if the erasure consists of only a single bad frame then the single bad frame is placed in this class; (2) a bad frame that is not the first bad frame in an erasure consisting of a consecutive series of bad frames; (3) the first good frame immediately following an erasure; and (4) a good frame that is not the first good frame immediately after an erasure.

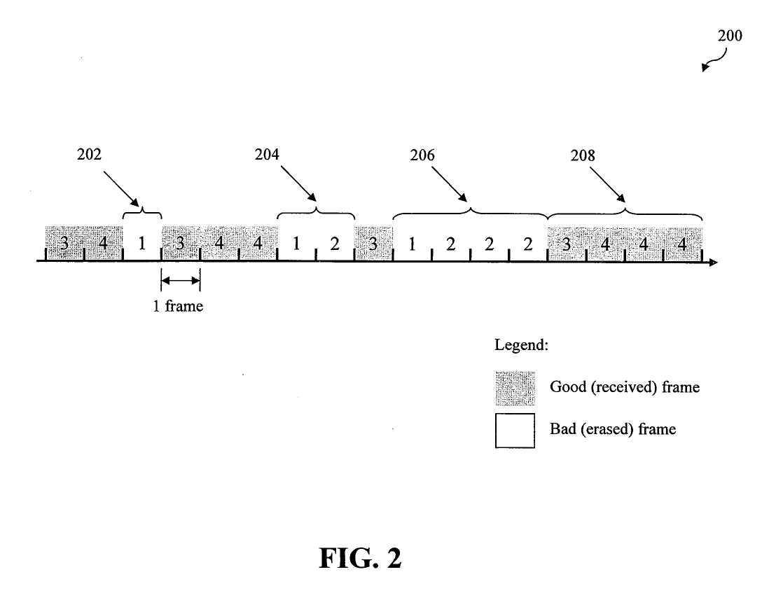

By way of illustration, FIG. 2 depicts a series of frames 200 of an input bit-stream that have been classified by system 100 in accordance with the foregoing classification scheme. In FIG. 2, the long horizontal arrowed line is a time line, with each vertical tick showing the location of the boundary between two adjacent frames. The further to the right a frame is located in FIG. 2, the newer (later) the frame is. Shaded frames represent good frames while frames that are not shaded represent bad frames.

As shown in FIG. 2, the series of frames 200 includes a number of erasures, including an erasure 202, an erasure 204 and an erasure 206. Erasure 202 consists of only a single bad frame, which is classified as a class 1 frame in accordance with the foregoing classification scheme. Erasures 204 and 206 each consist of a consecutive series of bad frames, wherein the first bad frame in each series is classified as a class 1 frame and each subsequent bad frame in each series is classified as a class 2 frame in accordance with the foregoing classification scheme. An exemplary series of good frames 208 following an erasure is also depicted in FIG. 2. In accordance with the foregoing classification scheme, the first good frame in series 208 is classified as a class 3 frame while the subsequent frames in series 208 are classified as class 4 frames.

As will be described in more detail herein, system 100 performs different tasks for different classes of frames. Furthermore, results generated while performing tasks for one class of frames may subsequently be used in processing other classes of frames. For this reason, it is difficult to illustrate the frame-by-frame operation of such an FEC scheme using a conventional block diagram. Accordingly, the block diagram of system 100 provided in FIG. 1 aims to illustrate the fundamental concepts of the FEC scheme rather than the step-by-step, module-by-module operation.

Individual functional blocks in system 100 may be inactive or bypassed, depending on the class of frame that is being processed. The following description of system 100 will make clear which functional blocks are active during which class of frames.

In FIG. 1, the solid arrows indicate the flow of speech signals or other related signals within system 100. The arrows with dashed lines indicate the control flow involving the updates of filter parameters, filter memory, and the like.

The manner of operation of system 100 when the frame of the input bit-stream that is being processed is a good frame will now be described. In this case, block 105 decodes the frame of the input bit-stream to generate a corresponding frame of decoded speech and then passes the frame of decoded speech to block 110 for storage in a decoded speech buffer. The decoded speech buffer also stores a portion of a decoded speech signal corresponding to one or more previously-decoded frames. In one implementation, the length of the decoded speech signal corresponding to previously-decoded frames that can be accommodated by the decoded speech buffer is one times a maximum pitch period plus a predefined analysis window size. The maximum pitch period may be, for example, between 17 and 20 milliseconds (ms), while the analysis window size may be between 5 and 15 ms.

If the frame being processed is a good frame that is not the first good frame immediately after an erasure (that is, it is a class 4 frame), then blocks 115, 120, 125, 130, 135 and 140 are inactive and blocks 145, 150, 155 and 160 are bypassed. In other words, the frame of the decoded speech signal produced by block 105 and stored in the decoded speech buffer is also provided as the output speech signal.

If, on the other hand, the frame being processed is the first good frame immediately after an erasure (that is, it is a class-3 frame), then due to the processing of the immediately previous frame (that is, the last bad frame of the last erasure), there should be a segment of a ringing signal already calculated and stored in block 140 (to be explained later). In this case, blocks 115, 120, 125, 130 and 135 are inactive and block 145 is bypassed. Block 150 performs an overlap-add (OLA) operation between the ringing signal segment stored in block 140 and the frame of the decoded speech signal stored in the decoded speech buffer to obtain a smooth transition from the stored ringing signal to the decoded speech signal. This is done to avoid waveform discontinuity at the beginning of the current frame of the output speech signal. The overlap-add length is typically shorter than the frame size. Blocks 155 and 160 are then bypassed. That is, the overlap-added version of the frame of the decoded speech signal stored in the decoded speech buffer is directly played out as the output speech signal.

If the frame being processed is the first bad frame in an erasure (that is, it is a class 1 frame), the following speech analysis operations are performed by system 100. Using the decoded speech signal stored in the decoded speech buffer, block 120 performs a long-term predictive analysis to derive certain long-term filter related parameters (pitch period, long-term predictor tap weight, extrapolation scaling factor, and the like). Block 115 performs a buzz reduction analysis which includes computing a pitch period multiple and class 2 extrapolation scaling factor to be used for processing any class 2 frames that may follow the class 1 frame.

Block 135 performs a short-term predictive analysis using the decoded speech signal stored in the decoded speech buffer to derive certain short-term filter parameters. The short term filter is also called the LPC (Linear Predictive Coding) filter in the speech coding literature.

Block 130 obtains a number of samples of the previous decoded speech signal, reverses the order, and saves them as short-term filter memory. Block 125 calculates the long-term filter memory by using a short-term filter to inverse-filter a segment of the decoded speech signal that is only one pitch period earlier than an overlap-add period at the beginning of the current output speech frame. The result of the inverse filtering is the short-term prediction residual or “LPC prediction residual” as known in the speech coding literature. Block 140 then scales the long-term filter memory segment so calculated by the long-term predictor tap weight, and then passes the resulting signal through a short-term synthesis filter whose coefficients are updated by block 135 and whose filter memory is set up by block 130. The output signal of such a short-term synthesis filter is the ringing signal to be used at the beginning of the current output speech frame (the first bad frame in an erasure).

Next, block 145 performs a first-stage periodic waveform extrapolation of the decoded speech signal up to the end of the overlap-add period, using the pitch period and an extrapolation scaling factor determined by block 120. Specifically, block 145 multiplies the decoded speech waveform segment that is one pitch period earlier than the current overlap-add period by the extrapolation scaling factor, and saves the resulting signal segment in the location corresponding to the current overlap-add period. Block 150 then performs the overlap-add operation to obtain a smooth transition from the ringing signal calculated by block 140 to the extrapolated speech signal generated by block 145. Next, block 155 performs a second-stage periodic waveform extrapolation from the end of the overlap-add period of the current output speech frame to the end of the overlap-add period in the next output speech frame (which is the end of the current output speech frame plus the overlap-add length). These extra samples beyond the end of the current output speech frame are not needed for generating the output samples of the current frame. They are calculated now and stored as the ringing signal for the overlap-add operation by block 150 for the next frame. Block 160 is bypassed, and the output of block 155 is directly played out as the output speech signal.

If the frame being processed is a bad frame that is not the first bad frame of an erasure (that is, it is a class 2 frame), then blocks 120, 125, 130, 135 and 140 are inactive. Block 145 performs a first-stage periodic waveform extrapolation up to the end of the overlap-add period in the same manner as described above for a class 1 frame except that block 145 now substitutes the pitch period multiple and class 2 extrapolation scaling factor provided by block 115 for the pitch period and extrapolation scaling factor provided by block 120. Block 150 performs an overlap-add operation between the ringing signal stored in block 140 (which represents the extra samples generated by block 155 beyond the end of the previous output speech frame) and the extrapolated speech signal generated by block 145. Block 155 performs the second-stage periodic waveform extrapolation from the end of the overlap-add period of the current output speech frame to the end of the overlap-add period in the next output speech frame in the same manner as described above for a class 1 frame except that block 150 now substitutes the pitch period multiple and class 2 extrapolation scaling factor provided by block 115 for the pitch period and extrapolation scaling factor provided by block 120.

If the total number of erased samples in the current erasure (including the samples in the current bad frame) is greater than or equal to N samples, then block 160 applies gain attenuation to reduce the magnitude of the output speech signal toward zero. In one embodiment, N is the minimum of (1) a predetermined number of consecutively-erased frames times the frame size and (2) a multiple of the pitch period previously determined by block 120. The predetermined number of consecutively-erased frames may be a tunable parameter. For simplicity, the gain scaling factor applied by block 160 may be an exponentially decaying function that starts at a value of 1 at the beginning of the current bad frame and decays exponentially sample-by-sample toward zero.

### C. Frame Erasure Concealment Method in Accordance with an Embodiment of the Present Invention

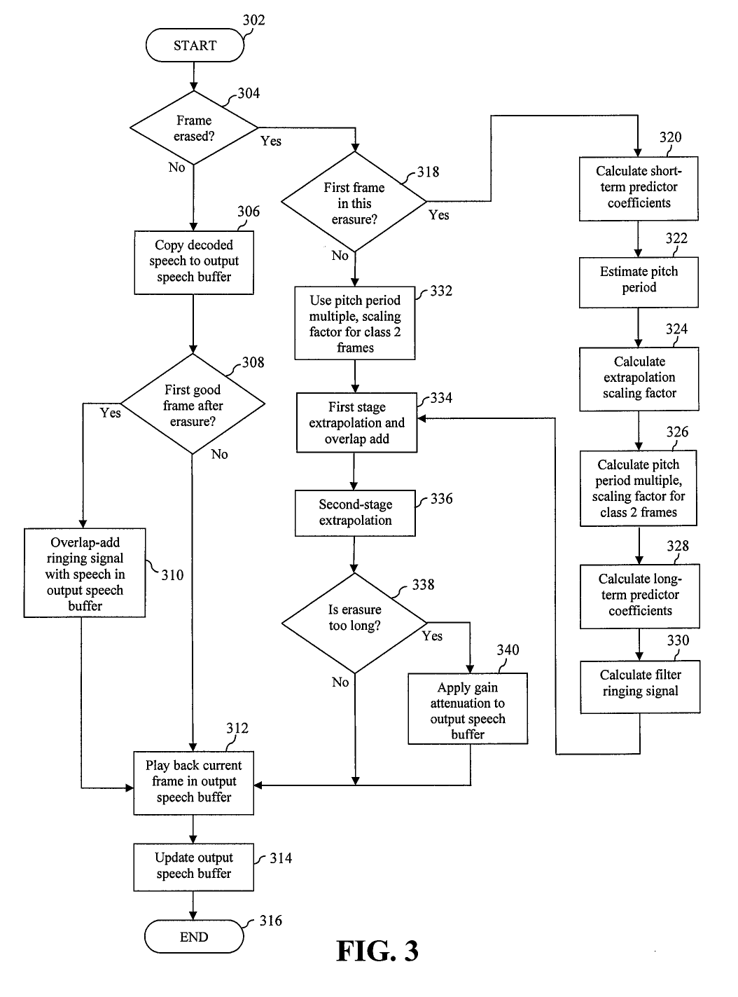

FIG. 3 depicts a flowchart 300 of a method of operation of system 100 in accordance with an embodiment of the present invention. Flowchart 300 is provided to help clarify the sequence of operations and control flow associated with the processing of each of the different classes of frames by system 100. Flowchart 300 describes steps involved in processing one frame of the input bit-stream received by system 100.

In FIG. 3, steps 304, 312, and 314 are performed during the processing of both good and bad frames of the input bit-stream. Steps 306, 308 and 310 are performed only during the processing of good frames of the input bit-stream. Steps 318, 320, 322, 324, 326, 328, 330, 332, 334, 336, 338 and 340 are performed only during the processing of bad frames of the input bit-stream.

As shown in FIG. 3, the processing of each frame of the input bit-stream begins at node 302, labeled “START.” The first processing step is to determine whether the frame being processed is erased as shown at decision step 304. If the answer is “No” (that is, the frame being processed is a good frame), then at step 306 the decoded speech samples generated by decoding the frame are moved to a corresponding location in an output speech buffer. At decision step 308, a determination is made as to whether the frame being processed is the first good frame after an erasure. If the answer is “No” (that is, the current frame is a class 4 frame), the decoded speech samples in the output speech buffer corresponding to the frame being processed are directly played back as shown at step 312.

If the answer at decision step 308 is “Yes” (that is, the frame being processed is a class 3 frame), then an overlap-add (OLA) operation is performed at step 310. The OLA is performed between two signals: (1) the frame of decoded speech produced by decoding the current frame of the input bit-stream, and (2) a ringing signal calculated during processing of the previous frame of the input bit-stream for the beginning portion of the current frame, such that the output of the OLA operation gradually transitions from the ringing signal to the decoded speech signal associated with the current frame. Specifically, the ringing signal is “weighted” (that is, multiplied) by a “ramp-down” or “fade-out” window that goes from 1 to 0, and the decoded speech signal is weighted by a “ramp-up” or “fade-in” window that goes from 0 to 1. The two window-weighted signals are summed together, and the resulting signal is placed in the portion of the output speech buffer corresponding to the beginning portion of the decoded speech signal for the current frame, overwriting the decoded speech samples originally stored in that portion of the output speech buffer.

The sum of the ramp-down window and the ramp-up window at any given time index is 1. Various windows such as the triangular window or raised cosine window can be used. Such OLA operations are well known by persons skilled in the art. An example length of the overlap-add window (or the overlap-add length) used during step 310 is on the order of 2.5 ms, which is 20 samples for 8 kHz telephone-bandwidth speech and 40 samples for 16 kHz wideband speech.

After step 310 is completed, control flows to step 312, during which the decoded speech samples in the output speech buffer corresponding to the current frame (as modified by the OLA operation of step 310) are played back. Next, at step 314, the output speech buffer is updated in preparation for processing of the next frame of the input bit-stream. The update involves shifting the contents of the buffer by one frame of output speech in preparation for the next frame.

For convenience of description, a vector notation will be used to illustrate how step 314 and other steps work. Let the notation x(1:N) denote an N-dimensional vector containing the first through the N-th element of the x( ) array. In other words, x(1:N) is a short-hand notation for the vector [x(1) x(2) x(3) . . . x(N) ] if x(1:N) is a row vector. Let xq( ) be the output speech buffer. Further let F be the output speech frame size in samples, Q be the number of previous output speech samples in the xq( ) buffer, and let L be the length of overlap-add operation used in steps 310 and 334 of flowchart 300. Then, the vector xq(1:Q) corresponds to the previous output speech samples up to the last sample of the last frame of output speech, the vector xq(Q+1:Q+F) corresponds to the current frame of output speech, and the vector xq(1:Q+L) corresponds to all speech samples up to the end of the overlap-add period of the current frame of output speech.

During step 314, the output speech buffer is shifted and updated. During this step, the vector xq(1+F:Q+L+F) is copied to the vector position occupied by xq(1:Q+L). In other words, the content of the output speech buffer is shifted by F samples. After such buffer update, control then flows to node 316, labeled “END”, which represents the end of the frame processing loop. To process the next frame, control simply returns to node 302, labeled “START”, and then the method of flowchart 300 is repeated.

Returning now to decision step 304, if the answer at that step is “Yes” (in other words, the frame of the input-stream that is being processed is erased), then at decision step 318 it is determined whether the erased frame is the first bad frame in an erasure. If the answer is “Yes”, the erased frame is a class 1 frame. Responsive to determining that the erased frame is a class 1 frame, steps 320, 322, 324, 326, 328 and 330 are performed as described below.

During step 320, a so-called “LPC analysis” is performed to update the coefficients of a short-term predictor. Let M be the filter order of the short-term predictor. Then the short-term predictor can be represented by the transfer function

$$P ( z ) = {\sum }_{i = 1}^{M} {a}_{i} {z}^{- i} ,$$

where aᵢ, i=1, 2, . . . , M are the short-term predictor coefficients. During step 320, the portion of the output speech signal stored in the vector xq(1:Q) is analyzed to calculate the short-term predictor coefficients aᵢ, i=1, 2, . . . , M. Any reasonable analysis window size, window shape, and LPC analysis method can be used. Various methods for performing an LPC analysis are described in the speech coding literature. To reduce the computational complexity and the code size, one embodiment of the present invention uses a relatively small rectangular window (which is equivalent to no windowing operation at all), with a window size of 80 samples for 8 kHz sampling (10 ms), and with the window applied to xq(Q−79:Q), and the short-term predictor order M is 8. It should be noted that this is in direct contrast to conventional LPC analysis methods, which typically utilize a significantly more complex window, such as Hamming window. If even lower complexity is desired, the short-term predictor order M can be further reduced to a smaller number.

To reduce the computational complexity and the code size even further, one embodiment of the present invention uses a “switched-adaptive” short-term predictor. In this case, a few short-term predictors are pre-designed, and a classifier is used to switch between them. As an example, one can design off-line a short-term predictor optimized for voiced speech and a second short-term predictor optimized for unvoiced speech; then, by computing a voicing measure and comparing it with a threshold to determine whether the speech is likely voiced or unvoiced, step 320 can switch between these two pre-designed short-term predictors accordingly. This approach will save significant code size due to the elimination of the conventional LPC analysis, and it can also reduce the computational complexity if the voiced/unvoiced decision has a low complexity. In fact, it is even possible to use a single fixed short-term p pp is estimated by analyzing the decoded speech stored in xq(1:Q), which corresponds to the last few good frames of the input bit-stream prior to the frame erasure. Pitch period estimation is well-known in the art. In principle, step 322 may use any one of a large number of possible pitch estimators to generate an estimated pitch period pp. One embodiment of the present invention uses a simple, low-complexity, and yet effective pitch estimator based on an average magnitude difference function (AMDF). This pitch estimator is described below.

To reduce the computational complexity, a coarse pitch period with reduced time resolution is first extracted by analyzing a 4:1 decimated speech signal. Due to this 4:1 decimation, the number of AMDF values that need to be calculated for a given pitch period range is reduced by a factor of 4, and for each AMDF the number of magnitude differences that need to be evaluated is also reduced by a factor of 4. Hence, when compared with an exhaustive AMDF search with full time resolution in the undecimated speech domain, the computational complexity is reduced by a factor of 4×4=16 when evaluating AMDF in this coarse pitch search in the 4:1 decimated domain.

This coarse pitch search algorithm is described below as Algorithm A. In the following description, DECF is the decimation factor, MIDPP is the middle point of the pitch period range, HPPR is half the pitch period range, PWSZ is the pitch analysis window size, and the symbol “←” means to update the variable on its left side with the expression on its right side. Note that the sum of magnitude difference (SMD) used in the algorithm below is closely related to AMDF, since AMDF is simply obtained by dividing SMD by the number of terms in the SMD calculation. Since each of the SMD values evaluated below has the same number of terms, minimizing the SMD is equivalent to minimizing the AMDF.

Algorithm A:

| 1. | For lag from MIDPP−HPPR to MIDPP+HPPR with an increment of | |
|---|---|---|
| | DECF, do the four steps in the indented part below: | |
| | a. | Initialize the sum of magnitude difference as smd = 0, initialize |
| | | minsmd to a number larger than the frame size times the |
| | | maximum magnitude value for speech samples, and initialize |
| | | maxsmd to 0. |
| | b. | For n from Q − PWSZ + DECF to Q with an increment of |
| | | DECF, do smd ← smd + \| xq(n) − xq(n − |
| | | lag) \| |
| | c. | If smd < minsmd, then set minsmd = smd and set pp = lag. |
| | d. | If smd > maxsmd, then set maxsmd = smd. |

At the end of the lag loop (step 1. above), the final value of pp is the desired coarse pitch period. As can be seen from the foregoing, Algorithm A is very simple, requiring only a small amount of code and low computational complexity. Note that conventional pitch estimators usually first filter the speech signal with a weighting filter to reduce the negative influence of the strong formant peaks on the accuracy of the pitch estimator, and then apply a low-pass anti-aliasing filter before performing decimation and the coarse pitch search. In contrast, the algorithm above uses the speech signal directly in the sum of magnitude difference calculation without using a weighting filter or an anti-aliasing filter. The omission of the weighting filter and the anti-aliasing filter reduces both the code size and the computational complexity, and it has been observed that such omission does not cause significant degradation of output speech quality.

By far the most popular metric used by pitch estimators to search for the pitch period is the correlation function or normalized correlation function. However, in fixed-point implementations, the correlation function has double the dynamic range of the speech signal. Furthermore, to avoid the square root operation, the normalized correlation function approach usually requires calculating the square of the correlation function which has four times the dynamic range of the speech signal. This means that fixed-point implementations of correlation-based pitch search algorithms usually have to keep track of an exponent or use the so-called “block floating-point” arithmetic to avoid overflow and keep sufficient precision at the same time. Thus, the resulting fixed-point implementation is usually quite complex and requires a large amount of code. In contrast, the SMD does not involve any multiplication and has the same dynamic range as the speech signal. As a result, the SMD-based Algorithm A above is very simple to implement in fixed-point arithmetic, and the amount of code used to implement Algorithm A should be considerably smaller than a correlation-based pitch search algorithm.

Once the coarse pitch has been estimated, a refined pitch search is performed in the neighborhood of the coarse pitch period. An adaptive pitch refinement search window size rfwsz is used and is selected to be the coarse pitch period or 10 ms, whichever is smaller. Note that to reduce the amount of code, Algorithm A described above is designed in such a way that it can be re-used for the pitch refinement search and pitch sub-multiple search (to be described below). To use it for the pitch refinement search, one just has to replace DECF by 1, replace PWSZ by rfwsz described above, replace MIDPP by the coarse pitch period, and replace HPPR by a small number such as 3. With such substitutions of parameter values, Algorithm A above performs the pitch refinement search, and the resulting pp is the refined pitch period pp. The resulting minsmd is assigned to rsmd.

The refined pitch period estimated in the manner described above may be an integer multiple of the true pitch period, especially for female speech. To avoid such a scenario, once the refined pitch period is obtained, a search around the neighborhoods of its integer sub-multiples is performed in the hope of finding the true pitch period if the refined pitch period is an integer multiple of the true pitch period. Algorithm B below may be used to perform this integer sub-multiple pitch search. Exemplary parameter values for 8 kHz sampling are MINPP=24, MAXSM=4, SMPSR=2, SMWSZ=30, and SMDTH=1.3. The function round(·) rounds off its argument to the nearest integer.

Algorithm B:

| | |
|---|---|
| 1. | Set sm to the integer portion of pp/MINPP, where MINPP is the |
| | minimum allowed pitch period. |
| 2. | If sm > MAXSM, then set sm = MAXSM. |
| 3. | While sm < 2, stop; otherwise, do the following steps. |
| 4. | Set pitch period sub-multiple to pps = round(pp/sm). |
| 5. | Use Algorithm A to find the lag in the neighborhood of pps that |
| | minimizes the SMD. Algorithm A is used with DECF replaced by |
| | 1, PWSZ replaced by SMWSZ, MIDPP replaced by pps, and |
| | HPPR replaced by SMPSR. The resulting output argument pp |
| | is assigned to the pitch period candidate ppc, and the resulting |
| | minsmd is assigned to smdc. |
| 6. | If smdc × rfwsz < SMDTH × SMWSZ × rsmd, then set the |
| | final pitch period pp = ppc, set rfwsz = SMWSZ, and stop. |
| 7. | Decrement sm by 1. That is, sm ← sm − 1. |
| 8. | Go back to step 3. |

To avoid division, 1/MINPP and 1/sm in Algorithm B above can be pre-calculated and stored. When this approach is used, the division becomes multiplication. Also, note that the condition smdc×rfwsz<SMDTH×SMWSZ×rsmd is equivalent to smdc/SMWSZ<SMDTH×(rsmd/rfwsz). Therefore, the condition is testing whether the new minimum AMDF at the pitch period candidate ppc is less than SMDTH times the minimum AMDF previously obtained during the pitch refinement search. If it is, then ppc is accepted as the final pitch period pp.

The example pitch period estimation algorithm described above for use in implementing step 322 is simple to implement, require only a small amount of code, has a low computational complexity, and yet is fairly effective, at least for FEC applications.

During step 324, an extrapolation scaling factor t is calculated. There are multiple ways to perform this function. One way is to calculate an optimal tap weight for a single-tap long-term predictor which predicts xq(Q−rfwsz+1:Q) by a weighted version of xq(Q−rfwsz+1−pp:Q−pp), where rfwsz is a pitch refinement search window size as discussed above in reference to step 322. The optimal weight, the derivation of which is well-known in the art, can be used as the extrapolation scaling factor t. One potential problem with this more conventional approach is that if the two waveform vectors xq(Q−rfwsz+1:Q) and xq(Q−rfwsz+1−pp:Q−pp) are not well-correlated (in other words, the normalized correlation is not close to 1), then the periodically extrapolated waveform calculated in steps 334 and 336 will tend to decay toward zero quickly. One way to avoid this problem is to divide the average magnitude of the vector xq(Q−rfwsz+1:Q) by the average magnitude of the vector xq(Q−rfwsz+1−pp:Q−pp), and use the resulting quotient as the extrapolation scaling factor t. The following Algorithm C calculates the extrapolation scaling factor t based on this principle.

Algorithm C:

| | |
|---|---|
| 1. | Set smt = the sum of magnitudes for the vector xq(Q−rfwsz+1:Q) |
| 2. | Set smb = the sum of magnitudes for the vector |
| | xq(Q−rfwsz+1−pp:Q−pp) |
| 3. | If smt < smb, |
| | Set t = smt / smb |
| | otherwise, |
| | Set t = 1 |

Note that smt≧0 and smb≧0. Therefore, if smt<smb, then smb>0 since smb>smt≧0. Hence, the expression t=smt/smb will not create a “divide-by-zero” problem. Furthermore, if the condition smt<smb is not true, then smt≧smb, and in this case t=smt/smb≧1, so t should be clipped to 1 to avoid a “blow up” of the output speech signal. Furthermore, Algorithm C above uses a single condition smt<smb to check for both the “divide-by-zero” problem and the need to clip t.

During step 326, a pitch period multiple Mpp and a class 2 extrapolation scaling factor Mt are calculated for use during the processing of any class 2 frames that may follow the class 1 frame. In performing this step, the minimum SMD value (minsmd) and the maximum SMD value (maxsmd) generated during the execution of Algorithm A (see step 322, above) are compared to determine whether the speech signal is evolving sufficiently from one pitch cycle to the next such that simply performing periodic waveform extrapolation at the pitch period will most likely result in buzzy or tonal artifacts. If it is determined that the speech signal is evolving sufficiently, then the pitch period multiple Mpp is calculated by multiplying the pitch period pp determined in step 322 by a factor Mult and the class 2 extrapolation scaling factor Mt is calculated by raising the extrapolation scaling factor t determined in step 324 to the power of Mult. However, if it determined that the speech signal is not evolving sufficiently, then the pitch period multiple Mpp is simply set to equal the pitch period pp determined in step 322 and the class 2 extrapolation scaling factor Mt is simply set to equal the extrapolation scaling factor t determined in step 324.

For example, in accordance with one embodiment of the present invention, the pitch period multiple Mpp and the class 2 extrapolation scaling factor Mt may be calculated in accordance with the following Algorithm D:

Algorithm D:

```
If (minsmd/maxsmd > 0.25),
    If (pp<FRSZ),
        Mult = 4
    Else
        Mult = min(3, MAXPP/pp)
    Mpp = pp * Mult
    Mt = t\hat{ }Mult
Else
        Mpp = pp
        Mt = t
```

where FRSZ represents the fixed frame size (e.g., 30 samples) and MAXPP represents a predetermined maximum pitch period.

In order to avoid performing the division by pp, the foregoing Algorithm D may be implemented using a lookup table. To reduce the number of entries, pp may be divided by 4. For example, in accordance with such an implementation, Algorithm D may be replaced by the following Algorithm D′:

Algorithm D′:

```
If (minsmd/maxsmd > 0.25),
    Mult = ppmultbl[floor(pp/4)]
    Mpp = pp * Mult
    Mt = t\hat{ }Mult
Else
    Mpp = pp
    Mt = t
```

wherein the function floor(x) is a function that returns the highest integer less than or equal to x. To save codespace, the desired multiplying factor Mult is obtaining through the lookup table ppmulttbl:

| | | | |
|---|---|---|---|
| ppmulttbl = | 4 | for | pp/4 < 8; |
| | 3 | for | 8 <= pp/4 < 12; |
| | 2 | for | 12 <= pp/4 < 18; and |
| | 1 | for | pp/4 > 18. |

During step 328, a long-term predictor tap weight, or the long-term filter memory scaling factor β, is calculated. One conventional way to obtain this value β is to calculate a short-term prediction residual signal first, and then calculate an optimal tap weight of the single-tap long-term predictor for this short-term prediction residual at a pitch period of pp. The resulting optimal tap weight can be used as β. However, doing so requires a long buffer for the short-term prediction residual signal. To reduce computational complexity and memory usage, it has been found that reasonable performance can be obtained by simply scaling the extrapolation scaling factor t by a positive value somewhat smaller than 1. It is found that calculating the long-term filter memory scaling factor as β=0.75×t provides good results.

During step 330, the ringing signal of a cascaded long-term synthesis filter and short-term synthesis filter is calculated for the first L samples of the output speech frame corresponding to the first bad frame in the current erasure. For voiced speech, this ringing signal tends to naturally “extend” the speech waveform in the previous frame of the output speech signal into the current frame in a smooth manner. Hence, it is useful to overlap-add the ringing signal with a periodically extrapolated speech waveform in process 334 to ensure a smooth waveform transition between the last good output speech frame and the output speech frame associated with the bad frame of the current erasure.

A common way to implement a single-tap all-pole long-term synthesis filter is to maintain a long delay line (that is, a “filter memory”) with the number of delay elements equal to the maximum possible pitch period. Since the filter is an all-pole filter, the samples stored in this delay line are the same as the samples in the output of the long-term synthesis filter. To save the memory required by this long delay line, in one embodiment of the present invention, such a delay line is eliminated, and the portion of the delay line required for long-term filtering operation is approximated and calculated on-the-fly from the decoded speech buffer.

To calculate a filter ringing signal corresponding to the time period of xq(Q+1:Q+L), the portion of the long-term filter memory required for such operation is one pitch period earlier than the time period of xq(Q+1:Q+L). Let e(1:L) be the portion of the long-term synthesis filter memory (in other words, the long-term synthesis filter output) that when passed through the short-term synthesis filter will produce the desired filter ringing signal corresponding to the time period of xq(Q+1:Q+L). In addition, let pp be the pitch period to be used for the current frame. Then, the vector e(1:L) can be approximated by inverse short-term filtering of xq(Q+1−pp:Q+L−pp).

This inverse short-term filtering may be achieved by first assigning xq(Q+1−pp−M:Q−pp) as the initial memory (or “states”) of a short-term predictor error filter, represented as A(z)=1−P(z), and then filtering the vector xq(Q+1−pp:Q+L−pp) with this properly initialized filter A(z). The corresponding filter output vector is the desired approximation of the vector e(1:L). Let us call this approximated vector e(1:L). It is only an approximation because the coefficients of A(z) used in the current frame may be different from an earlier set of the coefficients of A(z) corresponding to the time period of xq(Q+1−pp:Q+L−pp) if pp is large.

Note that the vector xq(Q+1−pp−M:Q−pp) contains simply the M samples immediately prior to the vector xq(Q+1−pp:Q+L−pp) that is to be filtered, and therefore it can be used to initialize the memory of the all-zero filter A(z) so that it is as if the all-zero filter A(z) had been filtering the xq( ) signal since before it reaches this point in time.

After the inverse short-term filtering of the vector xq(Q+1−pp:Q+L−pp) with A(z), the resulting output vector \tilde{e}(1:L) is multiplied by a long-term filter memory scaling factor β, which is an approximation of the tap weight for the single-tap long-term synthesis filter used for generating the ringing signal. The scaled long-term filter memory β\tilde{e}(1:L) is an approximation of the long-term synthesis filter output for the time period of xq(Q+1:Q+L). This scaled vector β\tilde{e}(1:L) is further passed through an all-pole short-term synthesis filter represented by 1/A(z) to obtain the desired filter ringing signal, designated as r(1:L). Before the 1/A(z) filtering operation starts, the filter memory of this all-pole filter 1/A(z) is initialized to xq(Q−M+1:Q)—namely, to the last M samples of the previous output speech frame. This filter memory initialization is done such that the delay element corresponding to aᵢ is initialized to the value of xq(Q+1−i) for i=1, 2, . . . , M.

Such filter memory initialization for the short-term synthesis filter 1/A(z) basically sets up the filter 1/A(z) as if it had been used in a filtering operation to generate xq(Q−M+1:Q), or the last M samples of the output speech in the last frame, and is about ready to filter the next sample xq(Q+1). By setting up the initial memory (filter states) of the short-term synthesis filter 1/A(z) this way, and then passing β\tilde{e}(1:L) through such a properly initialized short-term synthesis filter, a filter ringing signal will be produced that tends to naturally “extend” the speech waveform in the last frame into the current frame in a smooth manner.

After the filter ringing signal vector r(1:L) is calculated in step 330, this ringing vector r(1:L) is used in the overlap-add operation of step 334.

During step 334, the operations of blocks 145 and 150 as described above in reference to FIG. 1 are performed. Specifically, let t be the extrapolation scaling factor, and assume that the pitch period is greater than the overlap-add period (i.e., pp≧L), then step 334 involves first calculating xq(Q+1:Q+L)=t×xq(Q+1−pp:Q+L−pp). Next, xq(Q+1:Q+L) is overlap-added with r(1:L). That is, xq(Q+n)=wu(n)×xq(Q+n)+wd(n)×r(n), for n=1, 2, . . . , L, where wu(n) and wd(n) are the n-th sample of the ramp-up window and ramp-down window, respectively, and wu(n)+wd(n)=1.

If the pitch period is smaller than the overlap-add period (pp<L), the first-stage extrapolation can be performed in a sample-by-sample manner to avoid copying waveform discontinuity from the beginning of the frame to a pitch period later before the overlap-add operation is performed. Specifically, the first-stage extrapolation with overlap-add may be performed by the following algorithm.
For n from 1, 2, 3, . . . , to L, do the next line:

xq(Q+n)=wu(n)×t×xq(Q+n−pp)+wd(n)×r(n)

This algorithm works regardless of the relationship between pp and L. Thus, in an embodiment it may be used in all cases to avoid the checking of the relationship between pp and L.

After this first-stage extrapolation with overlap-add, the flow continues to step 336 of flowchart 300. During step 336, the output speech signal is further extrapolated from the (L+1)-th sample of the current frame to L samples after the end of the current frame. This second-stage extrapolation is carried out as xq(Q+L+1:Q+F+L)=t×xq(Q+L+1−pp:Q+F+L−pp). The extra L samples of extrapolated speech past the end of the current frame of output speech, namely, the samples in xq(Q+F+1:Q+F+L), is considered the “ringing signal” for the overlap-add operation at the beginning of the first good frame after the current erasure (a class 3 frame).

Referring back now to decision step 318 of flowchart 300, if the answer to the question in that decision step is “No” (that is, the current frame is a class 2 frame), then control flows to step 332. During this step, the pitch period pp determined during step 320 is replaced with the pitch period multiple Mpp determined during step 326 and the extrapolation scaling factor t is replaced with the class 2 extrapolation scaling factor Mt determined during step 326. These new values are used for performing the extrapolation functions of steps 334 and 336 for all remaining class 2 frames in the current erasure. Otherwise, steps 334 and 336 are carried out in the same manner as described above for class 1 frames.

After step 336 has ended, it is determined during decision step 338 whether the duration of the current erasure has exceeded a threshold such that gain attenuation should be applied. If the length of the current erasure has not exceeded such a threshold, then control flows to step 312 in FIG. 3, during which the current frame of output speech is played back from the output speech buffer. If the length of the current erasure has exceeded this threshold, then gain attenuation is applied in step 340 which has the effect of gradually reducing the magnitude of the output signal toward zero, and then control flows to step 312.

This gain attenuation toward zero is important, because extrapolating a waveform for too long will cause the output signal to sound unnaturally tonal and buzzy, which will be perceived by a listener as fairly bad artifacts. In speech, if the pitch cycle is held constant for 3-5 cycles, the listener may perceive a buzz, depending on the nature of the surrounding speech. Thus, in one embodiment of the present invention, the threshold for determining whether gain attenuation should be applied is made dependent on the pitch period pp determined in step 322.

For example, in one embodiment of the present invention, if the total number of erased samples in the current erasure (including the samples in the current bad frame) is greater than or equal to N samples, then gain attenuation is applied to reduce the magnitude of the output speech signal toward zero, wherein N is defined as the minimum of (1) a gain attenuation starting frame number GATTST (representative of a predetermined number of consecutively-erased frames) times the frame size FRSZ and (2) a multiple of the pitch period pp previously determined during step 322. For example N may be determined in accordance with the function:

N=min(GATTST*FRSZ,pp*4).

An exemplary value of the gain attenuation starting frame number GATTST is 7 for a packet size of 30 samples at 8 kHz sampling.

Persons skilled in the relevant art will understand that there are various ways to perform gain attenuation. One embodiment of the present invention uses a simple sample-by-sample exponentially decaying scheme that is simple to implement, requires only a small amount of code, and is low in computational complexity. This gain attenuation algorithm is described below as Algorithm E. The variable cfecount is a counter that counts how many consecutive frames into the current erasure the current bad frame is. An exemplary value of the gain attenuation factor GATTF is 125/127 for 8 kHz sampling. The derivation of the threshold value N was described in the previous paragraph.

Algorithm E:

1. If cfecount = 1, set gain = 1
2. If cfecount * FRSZ ≧ N, then do the following steps in the indented
part:

a. For n = Q +1, Q +2, Q +3, ..., Q+F+L, do next two steps

| | |
|---|---|
| i. | Set gain ← gain × GATTF |
| ii. | Set xq(n) ← gain × xq(n) |

In accordance with Algorithm E, the value of the variable gain is maintained as state memory from one frame to the next, such that the value of gain in a current frame is initially equal to the value of gain at the end of the processing of the previous frame.

After the attenuation of the speech signal in xq(Q+1:Q+F+L) during step 340, control flows to step 312. This completes the description of the flow chart in FIG. 3.

### D. Example Computer System Implementation

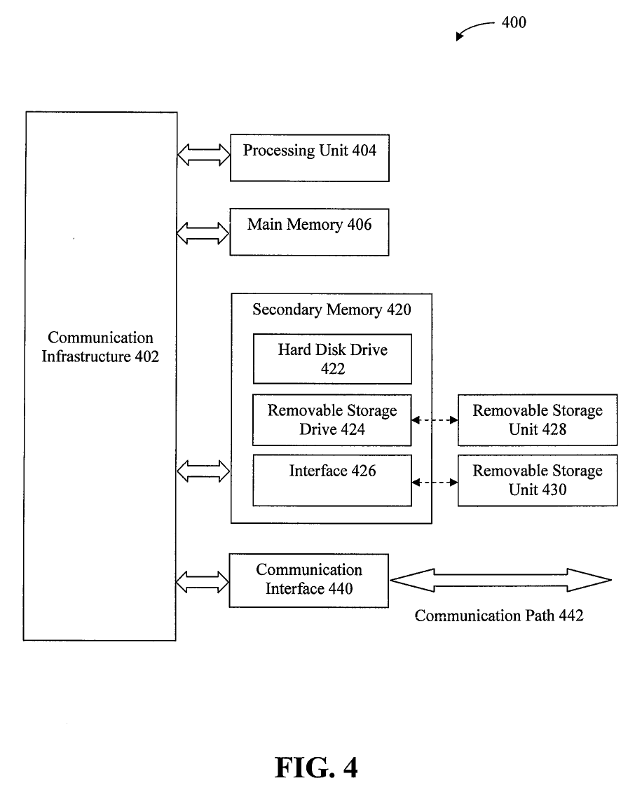

The following description of a general purpose computer system is provided for the sake of completeness. The present invention can be implemented in hardware, or as a combination of software and hardware. Consequently, the invention may be implemented in the environment of a computer system or other processing system. An example of such a computer system 400 is shown in FIG. 4. In the present invention, all of the blocks of system 100 depicted in FIG. 1 as well as all of the steps depicted in flowchart 300 of FIG. 3, for example, can execute on one or more distinct computer systems 400, to implement the various methods of the present invention.

Computer system 400 includes a processing unit 404, which may comprise one or more processors and/or processor cores. Processing unit 404 may comprise a special purpose or a general purpose digital signal processor. Processing unit 404 is connected to a communication infrastructure 402 (for example, a bus or network). Various software implementations are described in terms of this exemplary computer system. After reading this description, it will become apparent to a person skilled in the relevant art(s) how to implement the invention using other computer systems and/or computer architectures.

Computer system 400 also includes a main memory 406, preferably random access memory (RAM), and may also include a secondary memory 420. Secondary memory 420 may include, for example, a hard disk drive 422 and/or a removable storage drive 424, representing a floppy disk drive, a magnetic tape drive, an optical disk drive, or the like. Removable storage drive 424 reads from and/or writes to a removable storage unit 428 in a well known manner. Removable storage unit 428 represents a floppy disk, magnetic tape, optical disk, or the like, which is read by and written to by removable storage drive 424. As will be appreciated by persons skilled in the relevant art(s), removable storage unit 428 includes a computer usable storage medium having stored therein computer software and/or data.

In alternative implementations, secondary memory 420 may include other similar means for allowing computer programs or other instructions to be loaded into computer system 400. Such means may include, for example, a removable storage unit 430 and an interface 426. Examples of such means may include a program cartridge and cartridge interface (such as that found in video game devices), a removable memory chip (such as an EPROM, or PROM) and associated socket, and other removable storage units 430 and interfaces 426 which allow software and data to be transferred from removable storage unit 430 to computer system 400.

Computer system 400 may also include a communications interface 440. Communications interface 440 allows software and data to be transferred between computer system 400 and external devices. Examples of communications interface 440 may include a modem, a network interface (such as an Ethernet card), a communications port, a PCMCIA slot and card, etc. Software and data transferred via communications interface 440 are in the form of signals which may be electronic, electromagnetic, optical, or other signals capable of being received by communications interface 440. These signals are provided to communications interface 440 via a communications path 442. Communications path 442 carries signals and may be implemented using wire or cable, fiber optics, a phone line, a cellular phone link, an RF link and other communications channels.

As used herein, the terms “computer program medium” and “computer usable medium” are used to generally refer to media such as removable storage units 428 and 430 or a hard disk installed in hard disk drive 422. These computer program products are means for providing software to computer system 400.

Computer programs (also called computer control logic) are stored in main memory 406 and/or secondary memory 420. Computer programs may also be received via communications interface 440. Such computer programs, when executed, enable the computer system 400 to implement the present invention as discussed herein. In particular, the computer programs, when executed, enable processing unit 404 to implement the processes of the present invention, such as any of the methods described herein. Accordingly, such computer programs represent controllers of the computer system 400. Where the invention is implemented using software, the software may be stored in a computer program product and loaded into computer system 400 using removable storage drive 424, interface 426, or communications interface 440.

In another embodiment, features of the invention are implemented primarily in hardware using, for example, hardware components such as application-specific integrated circuits (ASICs) and gate arrays. Implementation of a hardware state machine so as to perform the functions described herein will also be apparent to persons skilled in the relevant art(s).

### E. Conclusion

While various embodiments of the present invention have been described above, it should be understood that they have been presented by way of example, and not limitation. It will be apparent to persons skilled in the relevant art that various changes in form and detail can be made therein without departing from the spirit and scope of the invention. For example, although a preferred embodiment of the present invention described herein utilizes a long-term predictive filter and a short-term predictive filter to generate a ringing signal, persons skilled in the relevant art(s) will appreciate that a ringing signal may be generated using a long-term predictive filter only or a short-term predictive filter only. Additionally, the invention is not limited to the use of predictive filters, and persons skilled in the relevant art(s) will understand that long-term and short-term filters in general may be used to practice the invention.

The present invention has been described above with the aid of functional building blocks and method steps illustrating the performance of specified functions and relationships thereof. The boundaries of these functional building blocks and method steps have been arbitrarily defined herein for the convenience of the description. Alternate boundaries can be defined so long as the specified functions and relationships thereof are appropriately performed. Any such alternate boundaries are thus within the scope and spirit of the claimed invention. One skilled in the art will recognize that these functional building blocks can be implemented by discrete components, application specific integrated circuits, processors executing appropriate software and the like or any combination thereof. Thus, the breadth and scope of the present invention should not be limited by any of the above-described exemplary embodiments, but should be defined only in accordance with the following claims and their equivalents.

What is claimed is:

1. A method for processing a series of erased frames of an encoded bit-stream to generate corresponding frames of an output speech signal comprising:
estimating a pitch period associated with a previously-generated portion of the output speech signal;
performing periodic waveform extrapolation based on the pitch period to generate a frame of the output speech signal corresponding to a first erased frame in the series of erased frames; and
performing periodic waveform extrapolation based on a multiple of the pitch period to generate one or more frames of the output speech signal corresponding to one or more erased frames that follow the first erased frame in the series of erased frames.

2. The method of claim 1, wherein performing periodic waveform extrapolation based on the multiple of the pitch period to generate the one or more frames of the output speech signal corresponding to the one or more erased frames that follow the first erased frame in the series of erased frames comprises:
calculating a parameter representative of a rate at which the previously-generated portion of the output speech signal is evolving over consecutive pitch periods; and
selectively performing periodic waveform extrapolation based on either the pitch period or the multiple of the pitch period to generate the one or more frames of the output speech signal corresponding to the one or more erased frames that follow the first erased frame in the series of erased frames depending on the value of the parameter.

3. The method of claim 2, wherein calculating the parameter representative of the rate at which the previously-generated portion of the output speech signal is evolving over consecutive pitch periods comprises:
calculating a sum of magnitude difference (SMD) between a first segment of the previously-generated portion of the output speech signal and each of a plurality of second segments of the previously-generated portion of the output speech signal, wherein each of the second segments is delayed with respect to the first segment by a unique lag;
identifying a smallest SMD and a largest SMD produced during the calculating step; and
dividing the smallest SMD by the largest SMD.

4. The method of claim 3, wherein estimating the pitch period associated with the previously-generated portion of the output speech signal comprises:
identifying the second segment that produced the smallest SMD during the calculating step;
estimating the pitch period as the unique lag associated with the identified second segment.

5. The method of claim 1, further comprising:
obtaining the multiple of the pitch period, wherein obtaining the multiple of the pitch period comprises
selecting a factor based on the pitch period, and
multiplying the pitch period by the factor to obtain the multiple of the pitch period.

6. The method of claim 5, wherein selecting the factor based on the pitch period comprises accessing a lookup table based on the pitch period.

7. The method of claim 1, wherein performing periodic waveform extrapolation based on the pitch period to generate the frame of the output speech signal corresponding to the first erased frame in the series of erased frames comprises selecting a segment of a previously-generated portion of the output speech signal based on the pitch period and multiplying the selected segment by a first extrapolation scaling factor; and
wherein performing periodic waveform extrapolation based on the multiple of the pitch period to generate the one or more frames of the output speech signal corresponding to the one or more erased frames that follow the first erased frame in the series of erased frames comprises selecting at least one segment of a previously-generated portion of the output speech signal based on the multiple of the pitch period and multiplying the selected at least one segment by a second extrapolation scaling factor.

8. The method of claim 7, further comprising calculating the second extrapolation scaling factor by raising the first extrapolation scaling to a power of M, wherein M is the multiplier used to obtain the multiple of the pitch period.

9. A method for processing an erased frame in a series of erased frames of an encoded-bit stream to generate a corresponding frame of an output speech signal, comprising:
performing periodic waveform extrapolation to generate a frame of the output speech signal corresponding to the erased frame;
calculating a duration of an erasure based on a number of consecutively-processed erased frames in the series of erased frames;
calculating a threshold based on at least a pitch period associated with a previously-generated portion of the output speech signal;
determining whether the duration of the erasure equals or exceeds the threshold; and
applying gain attenuation to the generated frame of the output speech signal responsive to determining that the duration of the erasure equals or exceeds the threshold.

10. The method of claim 9, wherein calculating the duration of the erasure based on the number of consecutively-processed erased frames in the series of erased frames comprises:
multiplying the number of consecutively-processed erased frames in the series of erased frames by a number of samples in each frame.

11. The method of claim 9, wherein calculating the threshold based on at least the pitch period associated with the previously-generated portion of the output speech signal comprises:
calculating the threshold as a multiple of the pitch period.

12. The method of claim 9, wherein calculating the threshold based on at least the pitch period associated with the previously-generated portion of the output speech signal comprises:
calculating the threshold as the minimum of a predetermined number of frames multiplied by a number of samples in each frame and a multiple of the pitch period.

13. The method of claim 9, wherein applying gain attenuation to the generated frame of the output speech signal comprises:
applying an exponentially decaying gain attenuation factor to the generated frame on a sample-by-sample basis.

14. A computer program product comprising a computer-readable medium having computer program logic recorded thereon for enabling a processing unit to process a series of erased frames of an encoded bit-stream to generate corresponding frames of an output speech signal, the computer program logic comprising:
first means for enabling the processing unit to estimate a pitch period associated with a previously-generated portion of the output speech signal;
second means for enabling the processing unit to perform periodic waveform extrapolation based on the pitch period to generate a frame of the output speech signal corresponding to a first erased frame in the series of erased frames; and
third means for enabling the processing unit to perform periodic waveform extrapolation based on a multiple of the pitch period to generate one or more frames of the output speech signal corresponding to one or more erased frames that follow the first erased frame in the series of erased frames.

15. The computer program product of claim 14, wherein the third means comprises:
means for enabling the processing unit to calculate a parameter representative of a rate at which the previously-generated portion of the output speech signal is evolving over consecutive pitch periods; and
means for enabling the processing unit to selectively perform periodic waveform extrapolation based on either the pitch period or the multiple of the pitch period to generate the one or more frames of the output speech signal corresponding to the one or more erased frames that follow the first erased frame in the series of erased frames depending on the value of the parameter.

16. The computer program product of claim 15, wherein the means for enabling the processing unit to calculate the parameter representative of the rate at which the previously-generated portion of the output speech signal is evolving over consecutive pitch periods comprises:
calculating means for enabling the processing unit to calculate a sum of magnitude difference (SMD) between a first segment of the previously-generated portion of the output speech signal and each of a plurality of second segments of the previously-generated portion of the output speech signal, wherein each of the second segments is delayed with respect to the first segment by a unique lag;
means for enabling the processing unit to identify a smallest SMD and a largest SMD produced by the calculating means; and
means for enabling the processing unit to divide the smallest SMD by the largest SMD.

17. The computer program product of claim 16, wherein the first means comprises:
means for enabling the processing unit to identify the second segment that produced the smallest SMD during the calculating step;
means for enabling the processing unit to estimate the pitch period as the unique lag associated with the identified second segment.

18. The computer program product of claim 14, wherein the computer program logic further comprises:
means for enabling the processing unit to obtain the multiple of the pitch period, wherein the means for enabling the processing unit to obtain the multiple of the pitch period comprises
means for enabling the processing unit to select a factor based on the pitch period, and
means for enabling the processing unit to multiply the pitch period by the factor to obtain the multiple of the pitch period.

19. The computer program product of claim 18, wherein the means for enabling the processing unit to select the factor based on the pitch period comprises means for enabling the processing unit to access a lookup table based on the pitch period.

20. The computer program product of claim 14, wherein the second means comprises means for enabling the processing unit to select a segment of a previously-generated portion of the output speech signal based on the pitch period and to multiply the selected segment by a first extrapolation scaling factor; and
wherein the third means comprises means for enabling the processing unit to select at least one segment of a previously-generated portion of the output speech signal based on the multiple of the pitch period and to multiply the selected at least one segment by a second extrapolation scaling factor.

21. The computer program product of claim 20, wherein the computer program logic further comprises:
means for enabling the processing unit to calculate the second extrapolation scaling factor by raising the first extrapolation scaling to a power of M, wherein M is the multiplier used to obtain the multiple of the pitch period.

22. A computer program product comprising a computer-readable medium having computer program logic recorded thereon for enabling a processing unit to process an erased frame in a series of erased frames of an encoded-bit stream to generate a corresponding frame of an output speech signal, the computer program logic comprising:
first means for enabling the processing unit to perform periodic waveform extrapolation to generate a frame of the output speech signal corresponding to the erased frame;
second means for enabling the processing unit to calculate a duration of an erasure based on a number of consecutively-processed erased frames in the series of erased frames;
third means for enabling the processing unit to calculate a threshold based on at least a pitch period associated with a previously-generated portion of the output speech signal;
fourth means for enabling the processing unit to determine whether the duration of the erasure equals or exceeds the threshold; and
fifth means for enabling the processing unit to apply gain attenuation to the generated frame of the output speech signal responsive to determining that the duration of the erasure equals or exceeds the threshold.

23. The computer program product of claim 22, wherein the second means comprises:
means for enabling the processing unit to multiply the number of consecutively-processed erased frames in the series of erased frames by a number of samples in each frame.

24. The computer program product of claim 22, wherein the third means comprises:
means for enabling the processing unit to calculate the threshold as a multiple of the pitch period.

25. The computer program product of claim 22, wherein the third means comprises:
means for enabling the processing unit to calculate the threshold as the minimum of a predetermined number of frames multiplied by a number of samples in each frame and a multiple of the pitch period.

26. The computer program product of claim 22, wherein the fifth means comprises:
means for enabling the processing unit to apply an exponentially decaying gain attenuation factor to the generated frame on a sample-by-sample basis.
